(19) United States
(12) Patent Application Publication
(10) Pub. No.: US 2009/0153983 A1
(43) Pub. Date: Jun. 18, 2009

(54) Imaging lens unit and camera module

(75) Inventors: Masaki Nakanishi, Ibaraki-shi (JP); Yoshiaki Minakawa, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD., IBARAKI-SHI (JP)

(21) Appl. No.: 12/314,498

(22) Filed: Dec. 11, 2008

(30) Foreign Application Priority Data
Dec. 12, 2007 (JP) 2007-320915

(51) Int. Cl. G02B 13/18

(52) U.S. Cl. 359/718

(57) ABSTRACT

An imaging lens unit includes, from an object side, a diaphragm, a first lens, and a second lens placed on an image side of the first lens. The first lens is a positive meniscus lens convex toward the object side, and at least one side of the first lens has an aspherical surface. The second lens is a meniscus lens convex toward the image side, and at least one side of the second lens has an aspherical surface. Further, a maximum value of an angle between a tangent to a surface on the image side of the second lens and a normal to an optical axis is in a range of 65° to 90° within an effective diameter of the second lens.

### BACKGROUND OF THE INVENTION

1. Field of the Invention

The present invention relates to an imaging lens unit and a camera module and, particularly, to an imaging lens unit composed of two image pickup lenses and a camera module including the imaging lens unit.

2. Description of Related Art

An image sensor is becoming smaller in size today. With the size reduction of the image sensor, imaging equipment is also becoming smaller in size. In order to achieve the size reduction of a camera module, the development of an imaging lens unit composed of two image pickup lenses is desired. However, it has been difficult to capture a high-quality image with use of such an imaging lens unit.

In order to capture a high-quality image, it is preferred that a ray is incident on an image sensor at a substantially perpendicular angle. In order for the ray to be incident on the image sensor substantially perpendicularly, it is generally necessary to increase back focus. The increase in back focus leads to an increase in optical path length. It is, however, necessary to shorten the optical path length in order to reduce the size of imaging equipment. Accordingly, it has been difficult to reduce the size of imaging equipment by shortening the optical path length and input a ray to the image sensor substantially perpendicularly to an image pickup surface at the same time.

Japanese Unexamined Patent Application Publication No. 2005-121685 discloses a technique of reducing the size of imaging equipment by adjusting the focal length of a first lens with respect to the focal length of the whole optical system.

However, because the back focus is short in the technique disclosed in Japanese Unexamined Patent Application Publication No. 2005-121685, an angle of incidence of a ray on an image pickup surface is larger than a right angle. It thus fails to capture a high-quality image.

The present invention has been accomplished to address the above concern, and an object of the present invention is thus to provide an imaging lens unit and a camera module that enable reduction of an optical path length and capture of a high-quality image.

### SUMMARY OF THE INVENTION

An imaging lens unit according to an embodiment of the present invention includes, from an object side, a diaphragm, a first lens, and a second lens placed on an image side of the first lens. The first lens is a positive meniscus lens convex toward the object side, and at least one side of the first lens has an aspherical surface. The second lens is a meniscus lens convex toward the image side, and at least one side of the second lens has an aspherical surface. Further, a maximum value of an angle between a tangent to a surface on the image side of the second lens and a normal to an optical axis is in a range of 65° to 90° within an effective diameter of the second lens.

In the embodiment of the present invention, the surface shape on the image side of the second lens is formed in such a way that the maximum value of the angle between the tangent to the surface on the image side of the second lens and the normal to the optical axis is in the range of 65° to 90° within the effective diameter of the second lens. Thus, an exit angle of a ray output from the second lens is small. Accordingly, a chief ray angle of a ray output from the second lens is also small. This allows an angle of a ray incident on an image sensor to be substantially perpendicular to the image sensor. Further, because the imaging lens unit is composed of two lenses, an optical path length is short. It is thereby possible to achieve both reduction of the optical path length and capture of a high-quality image.

The exit angle is an angle between a ray that is output from the second lens and the optical axis. The chief ray angle is an angle of incidence of a principal ray that is incident on the diagonal of the image sensor.

It is preferred that the second lens has a negative power.

This allows an exit pupil position to be located away from an image pickup surface. This thus enables a ray to be incident on the image sensor at a more perpendicular angle. It is thereby possible to obtain a suitable image.

Further, when a center thickness of the first lens is d1 and a center thickness of the second lens is d2, it is preferred to satisfy the following expression 1:

1.6<d2/d1<3

This enables reduction of the optical path length and increase in a light height of a light ray incident on the image sensor. Further, this allows the first lens to have an appropriate thickness for formation.

Furthermore, when a curvature radius of a surface on the object side of the first lens is R11 and a curvature radius of a surface on the image side of the first lens is R12, it is preferred to satisfy the following expression 2:

−5<(R11+R12)/(R11−R12)<−2

This enables the field curvature and astigmatism to be in balance with the distortion in the first lens.

A camera module according to another embodiment of the present invention includes the imaging lens unit described above.

It is thereby possible to achieve both reduction of an optical path length and capture of a high-quality image.

The present invention enables reduction of an optical path length and capture of a high-quality image.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a view showing an example of a camera module according to an embodiment of the present invention;

FIG. 2 is a view illustrating a ray passing through a lens surface with a tangent angle of 60°;

FIG. 3 is a view illustrating a ray passing through a lens surface with a tangent angle of 80°;

FIG. 4 is a view illustrating the center thickness of a lens and the light height of a light ray output from the lens;

FIG. 5 is a side view schematically showing a camera module according to an example 1 of the present invention;

FIG. 6A is a view showing spherical aberration in the example 1 of the present invention;

FIG. 6B is a view showing field curvature in the example 1 of the present invention;

FIG. 6C is a view showing distortion in the example 1 of the present invention;

FIG. 7 is a side view schematically showing a camera module according to an example 2 of the present invention;

FIG. 8A is a view showing spherical aberration in the example 2 of the present invention;

FIG. 8B is a view showing field curvature in the example 2 of the present invention; and

FIG. 8C is a view showing distortion in the example 2 of the present invention.

### DESCRIPTION OF THE PREFERRED EMBODIMENTS

An exemplary embodiment of the present invention is described hereinafter in detail with reference to the drawings. The present invention, however, is not limited to the following embodiment.

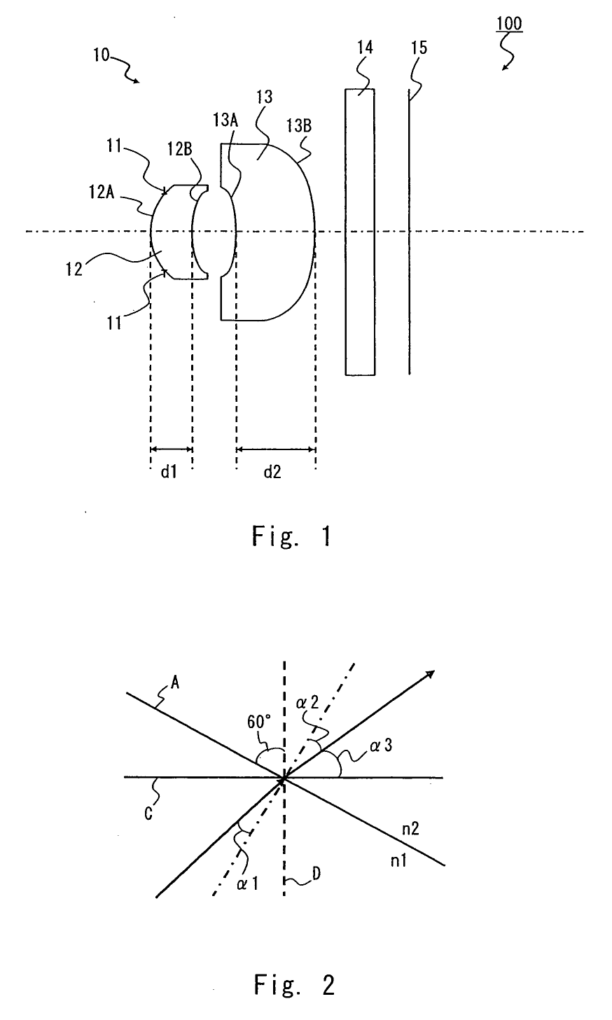

FIG. 1 shows an example of a camera module 100 according to an embodiment of the present invention. The camera module 100 includes an imaging lens unit 10, a cover glass 14, and so on.

The imaging lens unit 10 includes an aperture diaphragm 11 (diaphragm), a first lens 12 (first lens), a second lens 13 (second lens), and so on. They are arranged in the order of the aperture diaphragm 11, the first lens 12 and the second lens 13 from the object side to the image side. The cover glass 14 is placed between an image sensor 15 and the second lens 13.

The cover glass 14 has an infrared ray cut filter (IRCF) function or the like so as to prevent a ray different from visible light from entering the image sensor 15.

The image sensor 15 is made up of a solid-state image sensor such as a charge coupled device (CCD) and a complementary metal-oxide semiconductor (CMOS).

The first lens 12 is a positive meniscus lens that is convex toward the object side. At least one side of the first lens 12 has an aspherical surface.

The second lens 13 is a negative meniscus lens that is convex toward the image side. A refractive power of the second lens 13 may be positive. At least one side of the second lens 13 has an aspherical surface.

The lens surface is normally formed to be spherical. However, by forming the lens surface to be aspherical rather than spherical, it is possible to reduce the number of lenses necessary for correcting aberration, thereby shortening an optical path length.

Specifically, at least one surface shape of the first lens 12 and at least one surface shape of the second lens 13 are specified by the following expression:

$$Y ( h ) = \frac{{ch}^{2}}{1 + \sqrt{1 - ( K + 1 ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} \qquad Expression 3$$

where Y indicates a sag, c indicates a curvature, K indicates a constant of the cone, and h indicates a light height. Further, A4, A6, A8, A10, A12 and A14 indicate the 4th-order, 6th-order, 8th-order, 10th-order, 12th-order and 14th-order coefficients of aspherical surfaces, respectively. The curvature c and the curvature radius R satisfy c=1/R.

Further, by placing the aperture diaphragm 11 on the object side of the first lens 12, a distance from the aperture diaphragm 11 to the second lens 13 becomes longer. It is thereby possible to increase the light height of a light ray that reaches on a surface 13B on the image side (which is referred to hereinafter as an image-side lens surface 13B) of the second lens 13.

Furthermore, the second lens 13 is formed in such a way that the maximum value of an angle between a tangent to the image-side lens surface 13B and a normal to an optical axis (which is referred to hereinafter as a tangent angle) is in a range of 65° to 90° within an effective diameter of the image-side lens surface 13B of the second lens 13.

The effective diameter is the diameter of a range having optical properties as a lens, and it is the diameter of the boundary between a lens aspherical surface portion and an edge portion. The part of the lens outside the effective diameter is the edge portion.

By forming the second lens 13 in such a way that the maximum value of the tangent angle of the image-side lens surface 13B is in the range of 65° to 90° within the effective diameter of the second lens 13, an exit angle of ray that is output from the image-side lens surface 13B of the second lens 13 becomes smaller. A chief ray angle of ray that is incident on the image sensor 15 thereby becomes smaller. Preferably, the maximum value of the angle between the tangent to the image-side surface of the second lens 13 and the normal to the optical axis is in a range of 70° to 90° within the effective diameter of the second lens 13. More preferably, the maximum value of the angle between the tangent to the image-side surface of the second lens 13 and the normal to the optical axis is in a range of 75° to 90° within the effective diameter of the second lens 13.

The exit angle is an angle between a ray that is output from the lens and the optical axis. The chief ray angle is an angle of incidence of a principal ray that is incident on the diagonal of the image sensor 15.

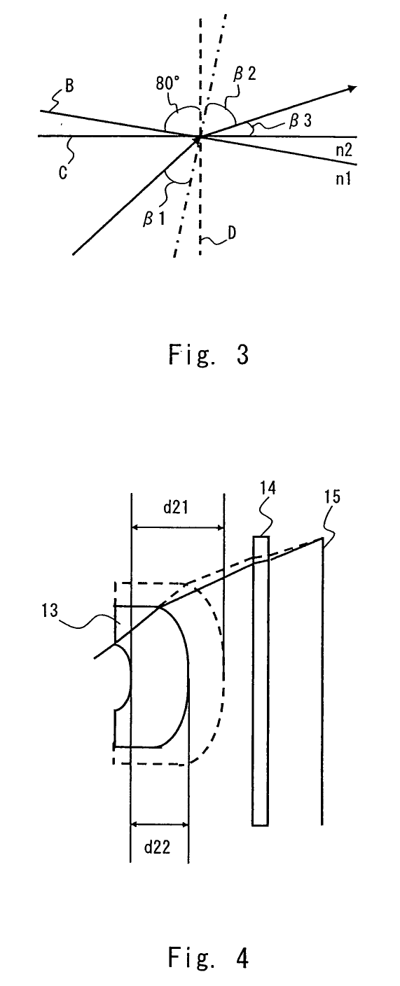

FIG. 2 shows an exit angle of a ray that is output from the image-side surface 13B of the second lens 13 in the case where the tangent angle is 60°. FIG. 3 shows an exit angle of a ray that is output from the image-side surface 13B of the second lens 13 in the case where the tangent angle is 80°.

In FIG. 2, the solid line A is a tangent to a lens surface in the position where a ray (which is indicated by the arrow in FIG. 2) is output. In FIG. 3, the solid line B is a tangent to a lens surface 13B in the position where a ray (which is indicated by the arrow in FIG. 3) is output.

In FIGS. 2 and 3, the solid line C is an optical axis, and the broken line D is a normal to the optical axis. Further, the alternate long and short dash line is a normal to the lens surface 13B.

It is assumed that n1 indicates a refractive index of a lens material, and n2 is a refractive index of air. Because n1>n2, the light that is output from the lens surface is refracted in the direction in which the exit angle becomes smaller due to Snell's law. In FIGS. 2 and 3, it is assumed that n1=1.54, n2=1.0, and the angle between an incident ray and the optical axis C is 44°. As shown in FIG. 2, an angle of incidence α1 on the lens surface with a tangent angle of 60° is 14°. On the other and, as shown in FIG. 3, an angle of incidence β1 on the lens surface with a tangent angle of 80° is 34°. Due to Snell's law, n1×sin(α1)=n2×sin(α2), and thus an angle of refraction α2 is 21.9°. Likewise, in FIG. 3, an angle of refraction β2 is 59.4°. Because α2+α3=60° (tangent angle) as in FIG. 2, an exit angle α3 is 38.1°. Likewise, in FIG. 3, an exit angle β3 is 20.6°. Accordingly, the exit angle β3 on the lens surface with a tangent angle of 80° is smaller than the exit angle α3 on the lens surface with a tangent angle of 60° by 17.5°. Thus, the exit angle is smaller with the lens surface having a larger tangent angle.

The second lens 13 has a negative power. This allows an exit pupil position to be located away from the image pickup surface. This thus enables a ray to be incident on the image sensor 15 at a more perpendicular angle. It is thereby possible to obtain a suitable image.

Further, the first lens 12 and the second lens 13 are formed so as to satisfy 1.6<d2/d1<3 when the center thickness of the first lens 12 is d1 and the center thickness of the second lens 13 is d2.

FIG. 4 schematically shows a relationship between the center thickness of the second lens 13 and the light height of a light ray that is output from the second lens 13. In FIG. 4, the broken line indicates the case where the center thickness of the second lens 13 is d21, and the solid line indicates the case where the center thickness of the second lens 13 is d22 (d21>d22). As shown in FIG. 4, as the center thickness d2 of the second lens 13 is larger, the light height h of the light ray that is output from the second lens 13 increases, thereby allowing the angle of the ray incident on the image sensor 15 to be more perpendicular to the image pickup surface.

Accordingly, the center thickness d2 of the second lens 13 is preferably larger. However, if the center thickness d2 of the second lens 13 is too large, the optical path length increases.

In order to shorten the optical path length, it is necessary to reduce the center thickness d1 of the first lens 12 also. However, if the center thickness d1 of the first lens 12 is too small, the edge portion of the first lens 12 becomes too thin, which causes the formation of the first lens 12 to be difficult due to manufacturing issues.

In light of this, by forming the first lens 12 and the second lens 13 so as to satisfy d2/d1>1.6, it is possible to obtain an appropriate light height h of a light ray output from the second lens 13. Further, by forming the first lens 12 and the second lens 13 so as to satisfy d2/d1<3, it is possible to easily form the first lens 12 because the center thickness d1 of the first lens 12 does not become too thin. It is also possible to shorten the optical path length.

It is preferred to form the first lens 12 and the second lens 13 so as to satisfy 1.75<d2/d1<2.8. It is more preferred to form the first lens 12 and the second lens 13 so as to satisfy 1.9<d2/d1<2.5. The light height is a distance from the optical axis to a ray in the direction perpendicular to the optical axis.

Further, the first lens 12 is formed so as to satisfy the following expression when a curvature radius of a surface 12A on the object side (which is referred to hereinafter as an object-side lens surface 12A) of the first lens 12 is R11 and a curvature radius of a surface 12B on the image side (which is referred to hereinafter as an image-side lens surface 12B) of the first lens 12 is R12:

−5<(R11+R12)/(R11−R12)<−2 Expression 2

This enables the field curvature and astigmatism to be in balance with the distortion in the first lens 12.

Specifically, if the value of (R11+R12)/(R11−R12) becomes equal to or smaller than −5, while the optical properties of the first lens 12 related to the field curvature and the astigmatism are improved, the optical properties related to the distortion are significantly degraded. On the other hand, if the value of (R11+R12)/(R11−R12) becomes equal to or larger than −2, while the optical properties of the first lens 12 related to the distortion are improved, the optical properties related to the field curvature and the astigmatism are significantly degraded.

It is preferred to form the first lens 12 so as to satisfy −4<(R11+R12)/(R11−R12)<−2.5. It is more preferred to form the first lens 12 so as to satisfy −3.5<(R11+R12)/(R11−R12)<−3.

### Example 1

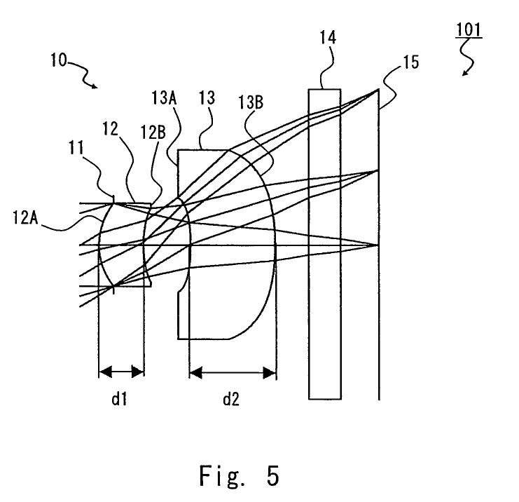

An example 1 of the present invention is described hereinafter. FIG. 5 is a schematic side view of a camera module 101 according to the example 1. In FIG. 5, from the object side, the aperture diaphragm 11 is referred to as a stop surface (ST), the object-side lens surface 12A of the first lens 12 is a second surface, the image-side lens surface 12B of the first lens 12 is a third surface, the object-side lens surface 13A of the second lens 13 is a fourth surface, the image-side lens surface 13B of the second lens 13 is a fifth surface, an object-side surface of the cover glass 14 is a sixth surface, an image-side surface of the cover glass 14 is a seventh surface, and an image pickup surface of the image sensor 15 is an eighth surface. Although a resin is used as a lens material of both the first lens 12 the second lens 13 in this example, a glass may be used instead.

The tables 1 and 2 show lens data according to the example 1.

The table 1 shows the curvature radius, the surface-to-surface distance, the refractive index and the Abbe number in the respective surfaces (ST, the second surface to the eighth surface) of the camera module 101 according to the example 1.

The table 2 shows the constant of the cone K and the coefficients of aspherical surfaces A4 to A14 that are used in the expression 3. The shape of the object-side lens surface 12A of the first lens 12 is specified by the curvature radius of the second surface shown in the table 1, each coefficient of the second surface shown in the table 2, and the expression 3. Likewise, the shapes of the image-side lens surface 12B of the first lens 12, the object-side lens surface 13A of the second lens 13, and the image-side lens surface 13B of the second lens 13 are specified by the curvature radius of the third, the fourth and the fifth surfaces shown in the table 1, each coefficient of the third, the fourth and the fifth surfaces shown in the table 2, and the expression 3.

TABLE 1

| | | Surface-to- | nd | νd |
|---|---|---|---|---|
| | Curvature | surface | (refractive | (Abbe |
| | radius | distance | index) | number) |
| ST | Infinity | −0.14 | | |
| 2nd | 0.644 | 0.43 | 1.54 | 56 |
| surface | | | | |
| 3rd | 1.170 | 0.46 | | |
| surface | | | | |
| 4th | −1.950 | 0.81 | 1.54 | 56 |
| surface | | | | |
| 5th | −2.365 | 0.32 | | |
| surface | | | | |
| 6th | Infinity | 0.30 | 1.52 | 64 |
| surface | | | | |
| 7th | Infinity | 0.36 | | |
| surface | | | | |
| 8th | Infinity | | | |
| surface | | | | |

TABLE 2

| | 2nd | 3rd | 4th | 5th |
|---|---|---|---|---|
| | surface | surface | surface | surface |
| K | 5.279579E−02 | 6.418114E+00 | 1.606860E+01 | 5.538704E+00 |
| A4 | 3.836047E−01 | 7.622089E−01 | −1.047019E+00 | −2.222185E−01 |
| A6 | −7.716212E+00 | −2.241517E+01 | 9.936858E+00 | 5.586414E−01 |
| A8 | 1.042638E+02 | 3.991618E+02 | −1.188095E+02 | −1.836015E+00 |
| A10 | −7.033800E+02 | −3.734426E+03 | 6.984546E+02 | 2.756660E+00 |
| A12 | 2.422889E+03 | 1.779896E+04 | −2.039688E+03 | −2.049027E+00 |
| A14 | −3.242230E+03 | −3.355105E+04 | 1.780460E+03 | 4.490119E−01 |

The table 3 shows the values of optical properties according to the example 1. The table 3 shows the focal length f, the F-number, the diagonal angle of view, the chief ray angle, the tangent angle θ, d2/d1, and (R11+R12)/(R11−R12). The F-number is a value obtained by dividing the focal length f by an incident pupil diameter. The diagonal angle of view is the maximum value of the angle of view that can form an image on the diagonal of the image sensor 15 (image height 100%). The tangent angle θ is the maximum value of the tangent angle of the image-side lens surface 13B of the second lens 13.

TABLE 3

| | |
|---|---|
| Focal length f | 2.38 |
| F-number | 3 |
| Diagonal angle of view | 62.0 |
| Chief ray angle | 26.0 |
| Tangent angle θ | 71.5 |
| d2/d1 | 1.9 |
| (R11 + R12)/(R11 − R12) | −3.4 |

As shown in the table 3, because the tangent angle θ is 71.5°, which is larger than 65°, the chief ray angle is 26.0°, thus enabling reduction of the chief ray angle. It is thereby possible to make the angle of a ray incident on the image sensor 15 more perpendicular to the image pickup surface.

Further, because d2/d1 is 1.9 as shown in the table 3, it is possible to increase the light height of a light ray that is output from the second lens 13 and allow the first lens 12 to have an appropriate center thickness. This facilitates the formation of the first lens 12.

Furthermore, because (R11+R12)/(R11−R12) is −3.4 as shown in the table 3, it is possible to bring the field curvature and astigmatism in balance with the distortion in the first lens 12.

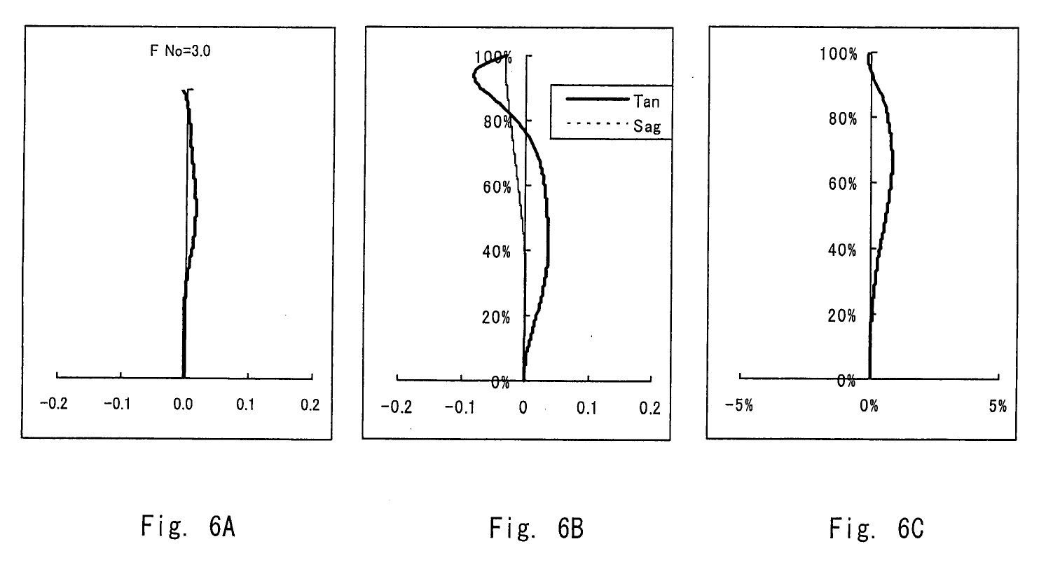

FIGS. 6A to 6C show aberrations in the example 1. FIG. 6A shows the spherical aberration, FIG. 6B shows the field curvature, and FIG. 6C shows the distortion. In FIG. 6B, T indicates a tangential image surface, and S indicates a sagittal image surface.

As shown in FIGS. 6A to 6C, in the imaging lens unit 10 according to the example 1, the spherical aberration, the field curvature and the distortion are appropriately corrected, thereby enabling suitable image formation performance of the camera module 101.

### Example 2

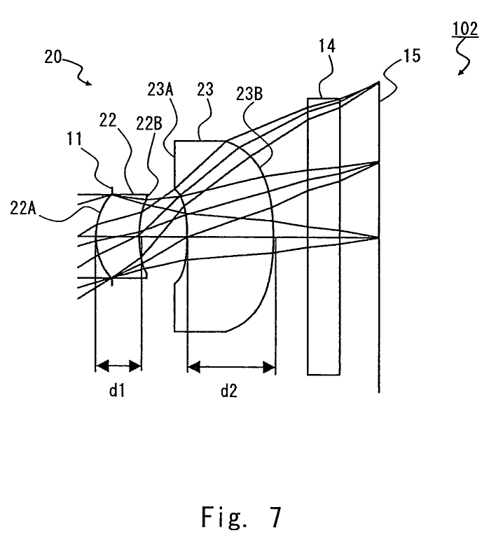

An example 2 of the present invention is described hereinafter. FIG. 7 is a schematic side view of a camera module 102 according to the example 2. As shown in FIG. 7, the elements of the camera module 102 according to the example 2 are substantially identical to those of the camera module 101 according to the example 1 except for a first lens 22 and a second lens 23. The substantially identical elements are denoted by the same reference symbols and not described below. Although a resin is used as a lens material of both the first lens 22 the second lens 23 in this example, a glass may be used instead.

Like the example 1, in FIG. 7, from the object side, the aperture diaphragm 11 is referred to as a stop surface (ST), an object-side lens surface 22A of the first lens 22 is a second surface, an image-side lens surface 22B of the first lens 22 is a third surface, an object-side lens surface 23A of the second lens 23 is a fourth surface, an image-side lens surface 23B of the second lens 23 is a fifth surface, an object-side surface of the cover glass 14 is a sixth surface, an image-side surface of the cover glass 14 is a seventh surface, and an image pickup surface of the image sensor 15 is an eighth surface.

The tables 4 and 5 show lens data according to the example 2.

The table 4 shows the curvature radius, the surface-to-surface distance, the refractive index and the Abbe number in the respective surfaces (ST, the second surface to the eighth surface) of the camera module 102 according to the example 2.

The table 5 shows the constant of the cone K and the coefficients of aspherical surfaces A4 to A14 that are used in the expression 3. The shapes of the object-side lens surface 22A of the first lens 22, the image-side lens surface 22B of the first lens 22, the object-side lens surface 23A of the second lens 23, and the image-side lens surface 23B of the second lens 23 are specified by the curvature radius of the second, the third, the fourth and the fifth surfaces shown in the table 4, each coefficient of the second, the third, the fourth and the fifth surfaces shown in the table 5, and the expression 3.

TABLE 4

| | | Surface-to- | nd | |
|---|---|---|---|---|
| | Curvature | surface | (refractive | νd |
| | radius | distance | index) | (Abbe number) |
| ST | Infinity | −0.15 | | |
| 2nd | 0.639 | 0.41 | 1.54 | 56 |
| surface | | | | |
| 3rd | 1.166 | 0.46 | | |
| surface | | | | |
| 4th | −1.962 | 0.82 | 1.54 | 56 |
| surface | | | | |
| 5th | −2.365 | 0.32 | | |
| surface | | | | |
| 6th | Infinity | 0.30 | 1.517 | 64.2 |
| surface | | | | |
| 7th | Infinity | 0.38 | | |
| surface | | | | |
| 8th | Infinity | | | |
| surface | | | | |

TABLE 5

| | 2nd surface | 3rd surface | 4th surface | 5th surface |
|---|---|---|---|---|
| K | 5.279579E−02 | 6.418114E+00 | 1.606860E+01 | 5.538704E+00 |
| A4 | 3.932413E−01 | 7.661769E−01 | −1.046637E+00 | −2.012171E−01 |
| A6 | −7.684039E+00 | −2.241602E+01 | 9.976103E+00 | 5.412931E−01 |
| A8 | 1.043189E+02 | 3.991286E+02 | −1.186843E+02 | −1.834722E+00 |
| A10 | −7.042848E+02 | −3.734850E+03 | 6.980310E+02 | 2.763201E+00 |
| A12 | 2.427832E+03 | 1.780914E+04 | −2.049592E+03 | −2.047085E+00 |
| A14 | −3.233255E+03 | −3.323684E+04 | 1.714437E+03 | 4.399365E−01 |

The table 6 shows the values of optical properties according to the example 2. The table 6 shows the focal length f, the F-number, the diagonal angle of view, the chief ray angle, the tangent angle θ, d2/d1, and (R11+R12)/(R11−R12). The tangent angle θ is the maximum value of the tangent angle of the image-side lens surface 23B of the second lens 23.

TABLE 6

| | |
|---|---|
| Focal length f | 2.38 |
| F-number | 3 |
| Diagonal angle of view | 62.6 |
| Chief ray angle | 25.9 |
| Tangent angle θ | 72.1 |
| d2/d1 | 2.0 |
| (R11 + R12)/(R11 − R12) | −3.4 |

As shown in the table 6, because the tangent angle θ according to the example 2 is 72.1°, which is larger than the tangent angle θ according to the example 1 shown in the table 3. Therefore, the chief ray angle is 25.9°, thus enabling further reduction of the chief ray angle. It is thereby possible to make the angle of a ray incident on the image sensor 15 more perpendicular to the image pickup surface.

Further, because d2/d1 is 2.0 as shown in the table 6, it is possible to further increase the light height of a light ray that is output from the second lens 23 and allow the first lens 22 to have an appropriate center thickness. This facilitates the formation of the first lens 22.

Furthermore, because (R11+R12)/(R11−R12) is −3.4 as shown in the table 6, it is possible to bring the field curvature and astigmatism in balance with the distortion in the first lens 22.

Particularly, in the example 2, the diagonal angle of view is larger than that of the example 1 by 0.6°. Generally, if the diagonal angle of view becomes larger, the chief ray angle becomes larger accordingly. However, because the tangent angle θ becomes larger by 0.5° and the value of d2/d1 increases by 0.1 in the example 2 compared with the example 1, the chief ray angle becomes smaller by 0.1°.

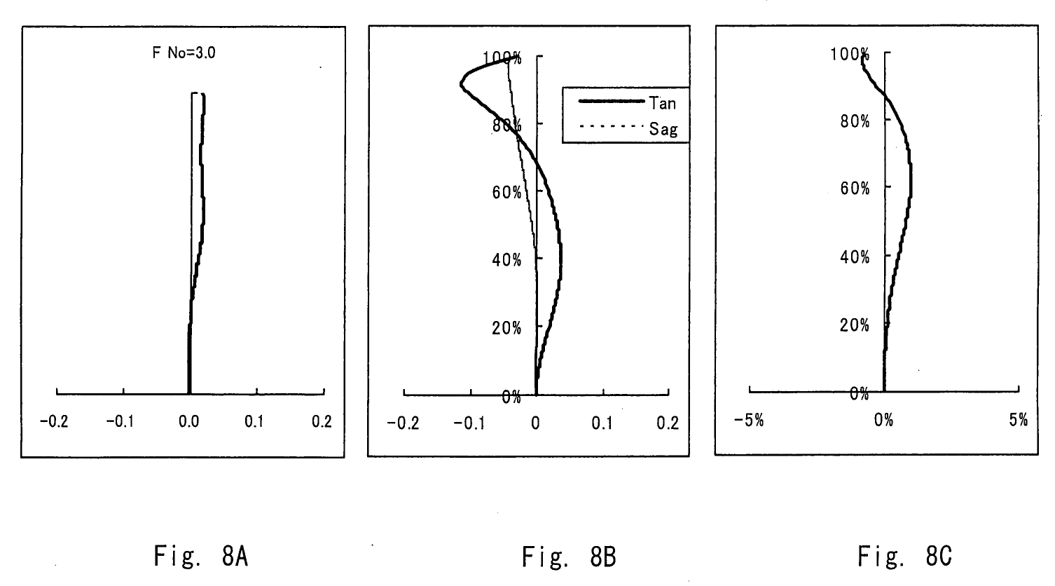

FIGS. 8A to 8C show aberrations in the example 2. FIG. 8A shows the spherical aberration, FIG. 8B shows the field curvature, and FIG. 8C shows the distortion. In FIG. 8B, T indicates a tangential image surface, and S indicates a sagittal image surface.

As shown in FIGS. 8A to 8C, in the imaging lens unit 20 according to the example 2, the spherical aberration, the field curvature and the distortion are appropriately corrected, thereby enabling suitable image formation performance of the camera module 102.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An imaging lens unit comprising, from an object side:
a diaphragm;
a first lens being a positive meniscus lens convex toward the object side, at least one side of the first lens having an aspherical surface; and
a second lens placed on an image side of the first lens, the second lens being a meniscus lens convex toward the image side, at least one side of the second lens having an aspherical surface, wherein
a maximum value of an angle between a tangent to a surface on the image side of the second lens and a normal to an optical axis is in a range of 65° to 90° within an effective diameter of the second lens.

2. The imaging lens unit according to claim 1, wherein
the second lens has a negative power.

3. The imaging lens unit according to claim 1, wherein
when a center thickness of the first lens is d1 and a center thickness of the second lens is d2, following expression 1 is satisfied:
1.6<d2/d1<3

4. The imaging lens unit according to claim 2, wherein
when a center thickness of the first lens is d1 and a center thickness of the second lens is d2, following expression 1 is satisfied:
1.6<d2/d1<3

5. The imaging lens unit according to claim 1, wherein
when a curvature radius of a surface on the object side of the first lens is R11 and a curvature radius of a surface on the image side of the first lens is R12, following expression 2 is satisfied:
−5<(R11+R12)/(R11−R12)<−2

6. The imaging lens unit according to claim 2, wherein
when a curvature radius of a surface on the object side of the first lens is R11 and a curvature radius of a surface on the image side of the first lens is R12, following expression 2 is satisfied:
−5<(R11+R12)/(R11−R12)<−2

7. The imaging lens unit according to claim 3, wherein
when a curvature radius of a surface on the object side of the first lens is R11 and a curvature radius of a surface on the image side of the first lens is R12, following expression 2 is satisfied:
−5<(R11+R12)/(R11−R12)<−2

8. A camera module comprising the imaging lens unit according to claim 1.

9. A camera module comprising the imaging lens unit according to claim 2.

10. A camera module comprising the imaging lens unit according to claim 3.

11. A camera module comprising the imaging lens unit according to claim 5.
